(19) United States
(12) Patent Application Publication
(10) Pub. No.: US 2005/0241149 A1
(43) Pub. Date: Nov. 3, 2005

(54) METHOD FOR MANUFACTURING A STATOR COMPONENT

(75) Inventors: Jan LUNDGREN, Grundsund (SE); Mats HALLQVIST, Grastorp (SE)

Correspondence Address: NOVAK DRUCE & QUIGG, LLP, 1300 EYE STREET NW, SUITE 400 EAST TOWER, WASHINGTON, DC, 20005, US

(73) Assignee: VOLVO AERO CORPORATION, Trollhattan (SE)

(21) Appl. No.: 10/906,323

(22) Filed: Feb. 14, 2005

Related U.S. Application Data
(63) Continuation of application No. PCT/SE03/01144, filed on Jul. 1, 2003.
(60) Provisional application No. 60/402,947, filed on Aug. 14, 2002.

(30) Foreign Application Priority Data
Aug. 14, 2002 (SE) 0202421-4

(51) Int. Cl. A23P 1/00; B29B 11/06

(52) U.S. Cl. 29/889.22; 29/889.2

(57) ABSTRACT

Method for manufacturing a stator component that is intended during operation to conduct a gas flow. The component is made up of at least two sections (113) in its circumferential direction, which sections each have at least one wall part (101,102) The sections are placed adjacent to each other and two wall parts, one from each of two adjacent sections, are connected in order together to form a means, extending in the radial direction of the component, for guidance of said gas flow and/or transmission of load during operation of the component.

### Cross-Reference To Related Applications

The present application is a continuation patent application of International Application No. PCT/SE03/01255 filed 1 Jul. 2003 which was published in English pursuant to Article 21(2) of the Patent Cooperation Treaty. Said International Application claims priority to Swedish Application No. 0202421-4 filed 14 Aug. 2002 and United States Provisional Application No. 60/402,947 filed 14 Aug. 2002. Said applications are expressly incorporated herein by reference in their entireties.

### FIELD OF THE INVENTION

The present invention relates to a method for manufacturing a stator component which is intended during operation to conduct a gas flow. The stator component can, for example, be used in a gas turbine and especially in a jet engine.

Jet engine is meant to include various types of engines which admit air at relatively low velocity, heat it by combustion and shoot it out at a much higher velocity. Accommodated within the term jet engine are, for example, turbojet engines and turbo-fan engines.

Of particular present interest is a component of such an engine comprising (including, but not necessarily limited to) an outer and an inner ring with wall parts arranged between the rings, and which can be arranged with a view to primarily being force-transmitting in the radial and axial direction. The wall parts can, for example, form hollow blades, which are usually shaped such that they offer as little air resistance as possible. The component can, for example, be arranged in a rear or front stand, or in an intermediate housing in a jet engine. The blades are often referred to in such a case as stays or “struts”. Struts can, however, also be formed by other types of parts than hollow blades.

### BACKGROUND OF THE INVENTION

Wall parts in the form of hollow blades are known to be arranged at a distance apart in the circumferential direction of the component between an inner and an outer ring. The hollow blades are joined together with the rings by welding. Each of the rings is firstly made, in this case, with portions of the same cross-dimensional shape and size as the blades, protruding in the radial direction. Such protruding portions are often referred to as “stubs”. Each of the blades is then welded to a protruding portion of this kind by means of a butt joint. The radially protruding portions are usually mill-cut from a ring. This is a time-consuming and costly operation.

### SUMMARY OF THE INVENTION

One object of the invention is to achieve a method for manufacturing a stator component which creates preconditions for a more high-strength component relative to known designs and having longer working life. Further, a more time-effective and cost-effective manufacture is facilitated.

This object is achieved by virtue of the fact that the component is made up of at least two sections in its circumferential direction, which sections each have at least one wall part. The sections are placed adjacent to each other and two wall parts, one from each of two adjacent sections, are connected so that together they form a means, extending in the radial direction of the component, for guiding said gas flow and/or transmission of load during operation of the component. Such gas-flow-guidance or load transmission means are thus made up of two separate wall parts, one from each section. This means will thus delimit adjoining gas ducts in the circumferential direction. The gas ducts thus extend in the axial direction of the component.

According to a preferred embodiment, a first of the adjacent sections is constructed by a first wall part and a second wall part being spaced apart so as to define a gas duct between them in the circumferential direction.

According to a refinement of the previous embodiment, a third wall part is arranged such that it extends between the first and second wall part and is connected thereto so as to define the gas duct in a first direction in the radial direction of the component. This produces a structurally strong construction, with the third wall part also acting as a stiffening means and spacer.

According to a refinement of the previous embodiment, the edge of the third wall part is laser-welded to the first and second wall part from, in the circumferential direction, an opposite side of the same in relation to the third wall part in such a way that the joined-together portions of the wall parts form a T-shaped joint.

By the edge of the wall part the elongated surface is meant which delimits the side faces, or flat sides, of the wall part. Given an appropriate choice of material parameters and welding parameters, a T-shaped joint with rounded corners, or at least a relatively smooth transition, can be obtained between the wall parts. This produces a structurally strong construction and hence an extended working life. Alternatively, a construction with thinner wall thicknesses and hence reduced weight can be obtained.

According to another preferred embodiment, the first and second wall part form portions of an essentially U-shaped single element.

### BRIEF DESCRIPTION OF THE FIGURES

The invention will be described in greater detail below, with reference to the embodiments shown in the appended drawings, in which:

FIGS. 1-5 are progressively assembled, perspective views showing, in projections, different steps in the manufacture of a component according to a first embodiment of the invention;

FIGS. 6-11 are progressively assembled, perspective views showing, in projections, different steps in the manufacture of a component according to a second embodiment of the invention; and

FIG. 12 is a cross sectional view of a laser-welded joint of the component.

### DETAILED DESCRIPTION OF PREFERRED EMBODIMENTS

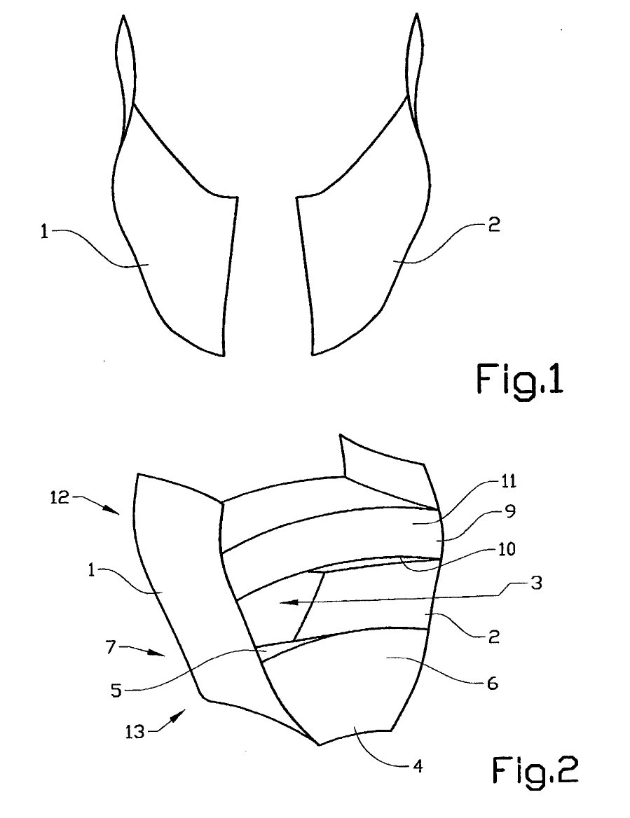

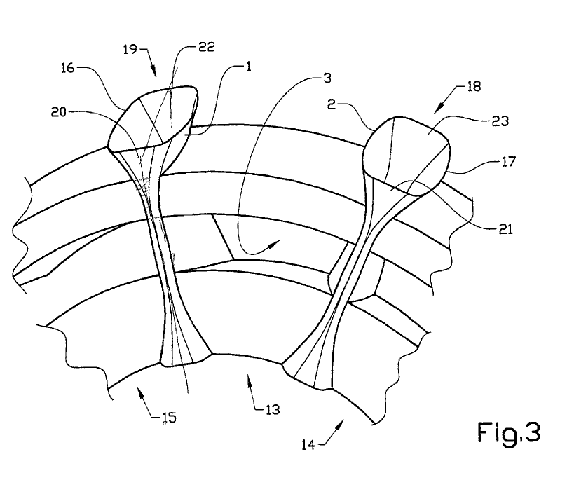

FIGS. 1 and 2 show a first wall part 1 and a second wall part 2 arranged to form part of a first section 13 (see FIG. 3) of a stator component configured according to a first embodiment. The wall parts 1, 2 have an essentially identical, curved shape and are placed at a distance apart such that the concave sides face each other. In other words, the wall parts 1, 2 represent in FIG. 1 mirror images of each other. The wall parts can, however, also have a mutually different configuration. The wall parts 1, 2 are arranged so as to define a gas duct 3 between them in the circumferential direction of the component, (see FIG. 2).

A first plate-shaped member 4, having a shape corresponding to the space between the first and second wall part 1, 2, is then placed between these as shown in FIG. 2. The plate-shaped member 4 has a U-shaped cross section and is constituted, for example, by a bent or folded plate. An intermediate portion 5 of the plate-shaped member 4 forms a third wall part, which limits the gas duct 3 inwardly in the radial direction. The side or plate portions 6, 7 of the plate-shaped member 4 have a shape and size corresponding to the space between the first and second wall part 1, 2. The flat sides of the side or plate portions 6, 7 thus face in the axial direction.

The third wall part 5 is connected to the first and second wall part 1, 2 by the edge of the third wall part 5 being laser-welded to the flat side of said first and second wall part 1, 2 from an opposite side of the same in relation to the third wall part in such a way that the joined-together portions of the wall parts form a T-shaped joint 8 as depicted in FIG. 12. The side portions 6, 7 of the plate-shaped member 4 are also connected to the first and second wall part 1, 2, exemplarily by laser-welding. Expediently, the side portions 6, 7 and the third wall part 5 are connected to the first and second wall part by a continuous weld.

Further, a second plate-shaped member 9 having a shape corresponding to the space between the first and second wall part 1, 2 is placed therebetween (see FIG. 2).

The plate-shaped member 9 has a square cross section and is constituted, for example, by a bent, welded-together plate. A portion 10 of the plate-shaped member 9 forms a fourth wall part which limits the gas duct 3 outwardly in the radial direction. The side or plate portions 11, 12 of the second plate-shaped member 9 have a shape and size corresponding to the space between the first and second wall part 1, 2. The flat sides of the side or plate portions 11, 12 thus face in the axial direction.

The fourth wall part 10 is connected to the first and second wall part 1, 2 by the edge of the fourth wall part 10 being laser-welded to the flat side of said first and second wall part 1, 2 from an opposite side of the same in relation to the third wall part in such a way that the joined-together portions of the wall parts form a T-shaped joint 8 (see FIG. 12). The side portions 11, 12 of the plate-shaped member 9 are also connected to the first and second wall part 1, 2; expediently by laser-welding.

A plurality of identically configured sections 13, 14, 15, made according to the description above, are then arranged side by side as shown in FIG. 3. The first and second wall parts 1, 2 of the first section 13 are connected to a corresponding wall part 16, 17 of the sections 14, 15 adjoining in the circumferential direction. The mutually connected wall parts 1, 16, 2, and 17 together form means 18, 19 for guidance of a gas flow and/or transmission of load in the radial direction during operation of the component. The adjoining wall parts 1, 16, 2, and 17 are connected in FIG. 3 by two cover walls 20, 21, 22 and 23 which thus enclose a space between the wall parts.

The wall parts 1, 2 thus extend substantially in the radial direction of the component. In addition, they have an extent substantially in the axial direction of the component.

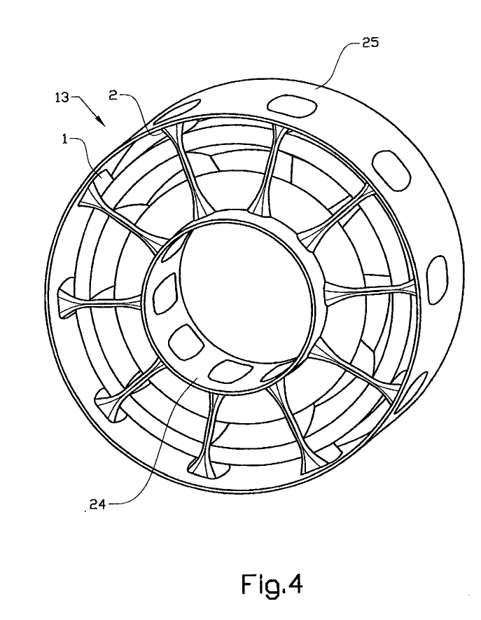

A ring element 24 is then arranged radially inside the first and second wall part 1, 2 and are connected thereto as shown in FIG. 4. Correspondingly, a ring element 25 is arranged radially outside the first and second wall part 1, 2 and is connected thereto. The ring elements 24, 25 are here constituted by plate-shaped bands, which are continuous in the circumferential direction of the component. The respective ring elements 24, 25 are connected to the wall parts 1, 2 by the ring-elements-facing edge of the wall parts 1, 2 being laser-welded to the flat side of the ring elements from an opposite side of these in relation to the wall parts in such a way that the joined-together portions form a T-shaped joint 8 as illustrated in FIG. 12. In other words, laser-welding is performed from the inside of the inner ring outwardly in the radial direction and from the outside of the outer ring inwardly in the radial direction.

A hole 27 is then cut out through the outer ring element 25 between each section or, in other words, at the positions for the spaces between two adjoining wall parts. These holes 27 can now be used to house various means for feeding of the component, such as means for the intake and outtake of oil and/or air, for housing instruments, such as electrical and metallic cables for transfer of information concerning measured pressure and/or temperature. The holes 27 can also be used to conduct coolant. Further, on each side of the component in the axial direction, a circular-shaped flange, or stiffening rib 28 is arranged which bears against the wall parts 1, 2 as depicted in FIG. 5.

In FIG. 5 the stator component 29 is shown as being made according to the first preferred embodiment of the invention. The gas ducts 3 thus extend in the axial direction of the component. The stator component 29 can, for example, form a load-bearing structure between bearings arranged radially/axially on the inside and structures connected on the outside.

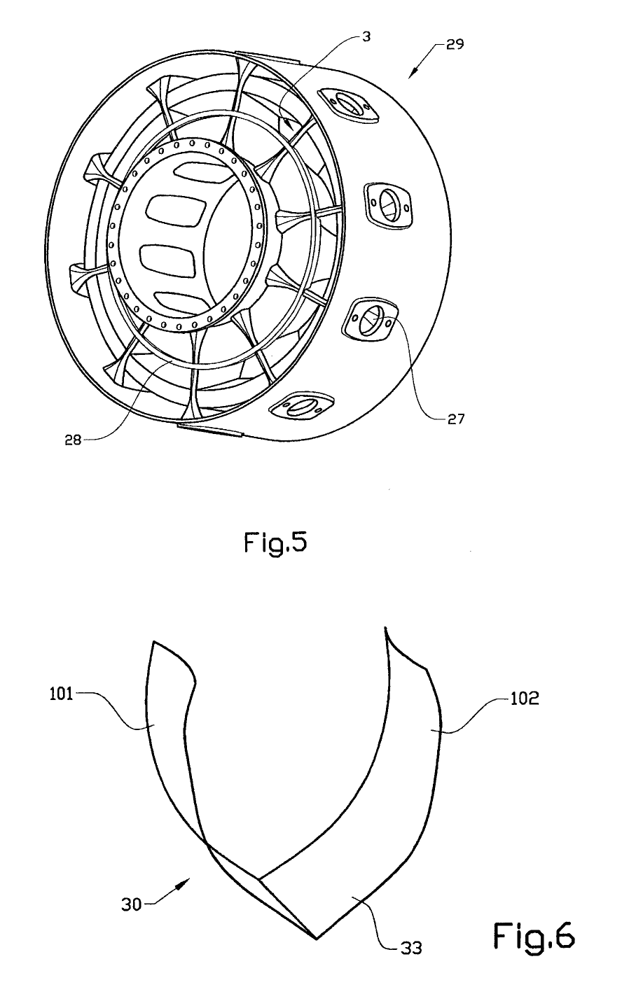

An alternative, second embodiment of the invention is shown in FIGS. 6-11. Only basic differences relative to the above-described first embodiment will be described below. A first wall part 101 and a second wall part 102 form portions of an essentially U-shaped single element 30 as shown in FIG. 6. The two wall parts 101, 102 are thus integrated in one and the same element. Each of the two wall parts 101, 102 thus form a portion of the side members of the U-shaped element 30. The U-shaped element 30 further has a base 33 which connects the two side members.

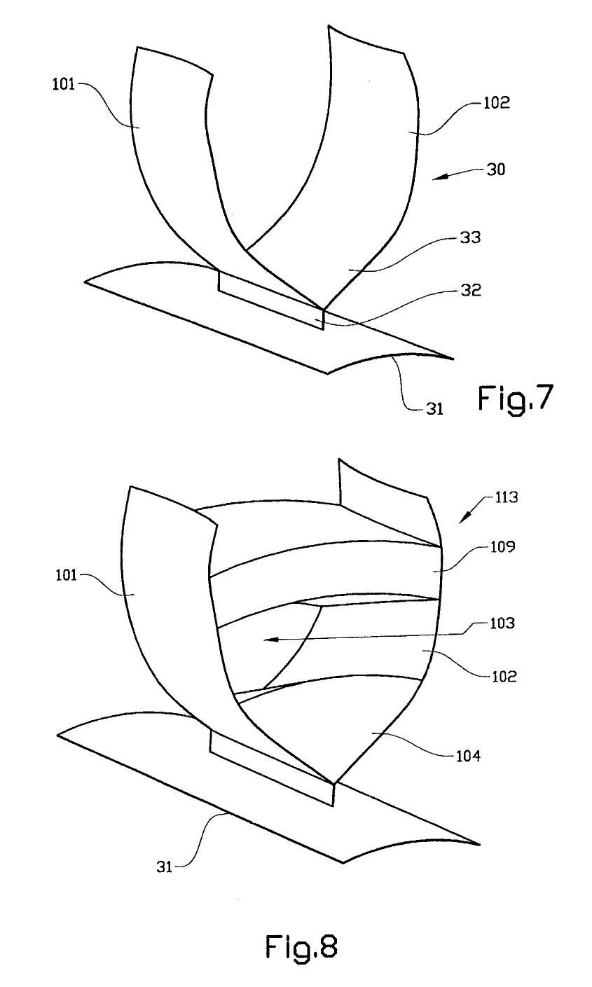

The base 33 of the U-shaped element 30 is connected to a ring element 31 which only forms part of a ring as shown in FIG. 7. The ring element 31 has for this purpose a protruding rib 32 that extends in the intended axial direction of the component. The base 33 has a pointed shape and the pointed portion is connected to the rib 32, for example, by welding. In other words, each section has a separate inner ring element 31.

A first and second plate-shaped member 104, 109, which have a shape corresponding to the space between the first and second wall part 101, 102, are then placed between these in the same manner as described above for the first embodiment as seen in FIG. 8. Each of the plate-shaped members 104, 109 comprise a wall part which limits the gas duct 103 inwardly in the radial direction. In FIG. 8, a section 113 is therefore shown.

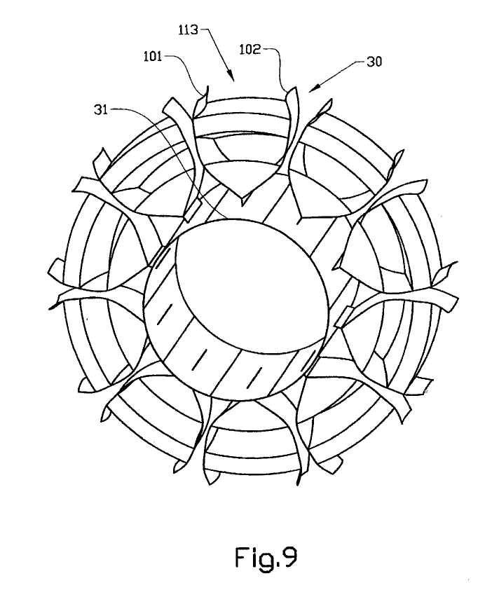

FIG. 9 shows a plurality of the sections which have been joined together in the circumferential direction. More precisely, the ring element 31 of each section has been joined together with the ring elements of adjacent sections. The joining-together can be realized, for example, by welding.

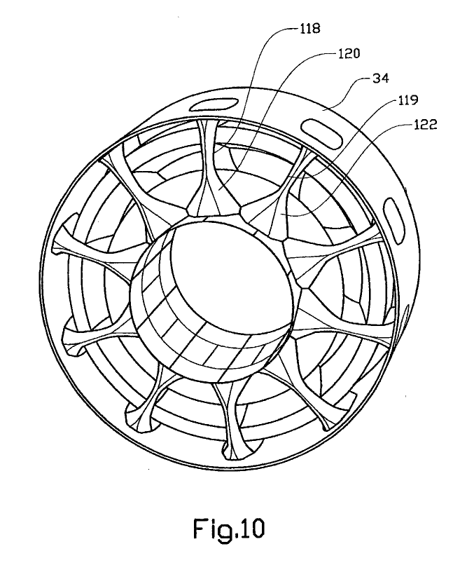

Cover walls 120, 122 are arranged between the wall parts of two adjoining sections and connected to the wall parts as shown in FIG. 10. The mutually connected wall parts together form means 118, 119 for guidance of a gas flow and/or transmission of load in the radial direction during operation of the component. In FIG. 1 0, an outer ring 34 has further been arranged outside the wall parts in the radial direction.

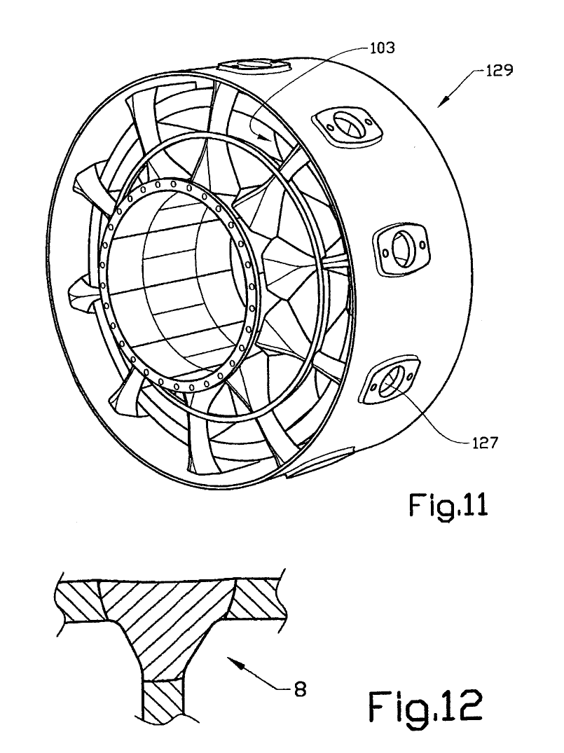

Holes 127 are then cut out through the outer ring 34 between each section or, in other words, at the positions for the spaces between two adjoining wall parts as shown in FIG. 11.

In FIG. 11 the stator component 129 is made according to the second preferred embodiment of the invention. The gas ducts 103 thus extend in the axial direction of the component. The stator component 129 can, for example, form a load-bearing structure between bearings arranged radially on the inside and a housing arranged radially on the outside.

In FIG. 12 the above-described T-shaped weld joint 8 is shown. By T-joint 8, it is more precisely meant that a portion of one of the wall parts and the ring elements, respectively, form the top part of the “T” and a portion of a second one of the wall parts forms the vertical part of the “T” which connects to the top part.

By plate-shaped members 4, 9, 104 and 109 it is meant that at least one portion has a plate-shape. The plate-shaped member can thus form the shape of a tube, a profile, and the like. In other words, the plate-shaped members can be made from a disk or a plate that is cut and folded into the desired shape, but other manufacturing techniques are also conceivable such as crosscutting of tubes or profiles having the desired cross-sectional shape.

The materials which are used for the wall parts which are intended to be welded are constituted by weldable materials, such as stainless steel, for example, of the type 347 or A286. Alternatively, nickel-based alloys, such as, for example, INC0600, INC0625, INC0718 and Hastaloy x, can be used. According to further variants, cobalt-based alloys, for example, of the type HAYNES 188 and HAYNES 230, can be used. Further, titanium alloys, such as Ti6-4, Ti6-2-4-2 and various types of aluminum alloys can be used. Combinations of different materials are also possible.

In the laser-welding, a Nd: YAG-laser is preferably used, but also other types of welding arrangements, for example a C02-LASER, can be used according to the invention. By precise coordination of the welding method, materials choice and wall parts dimensions, the T-shape in respect of a particular joint and a relatively gently rounded shape 22 of the inner angle between the wall parts are obtained with the laser-welding as shown in FIG. 12. The welding is expediently realized by means of a continuous weld. The rounded shape of the weld joints produces a high-strength construction and hence long working life of the component. This type of joining-together creates preconditions for a complete melting of the weld joint and fine transitions between the parts.

In order for the weld joint to end up in exactly the right position, a previously known joint-following technique can be used. Preferably a continuous weld joint is applied.

Each of the wall parts have the shape of a plate. By plate-shape it is meant that the wall part has two parallel side faces at a relatively short distance apart. Plate-shape is further meant to cover both the possibility of the wall part extending in one plane and that of it having a rounded or curved shape.

Should the wall parts have the purpose of being load-transmitting or load-bearing in the radial direction, that is to say when they form so-called struts or stays, an airfoil shape is not always required, nor the shape of hollow blades, but rather the plate-shape can suffice. A number of different configurations are, however, possible.

Should the second wall parts have the purpose of guiding a gas flow during operation of the component, the mutually connected second wall parts form the shape of a blade, for example, having an airfoil shape in cross section. Such a blade shape is utilized when the component is used in specific stator applications.

By the term ring element as used above in the description a continuously annular member is meant and a substantially annular member interrupted in the circumferential direction, or a part which, together with other like parts, is intended to form an annular member. When a plurality of such ring elements are joined together in the circumferential direction, a ring is formed. By ring a circumferential, band-shaped, preferably circular part is meant that spreads like a plate in the axial direction.

By the expression that the wall part extends in a certain direction with respect to the component, it is meant that at least one component of the extent of the wall part lies in this direction. Preferably, the wall part extends substantially in this direction. In other words, the wall part in question extends in a plane parallel with that direction.

The stator component can, for example, form an inlet part, an intermediate housing, a turbine-exhaust housing, that is to say a concluding housing part, or a part of this for a gas turbine. Its primary function is in this case to act as a bearing fastening, for the transmission of loads, and to provide a duct for gases.

The invention will not be deemed limited to the illustrative embodiments described above, but a host of further variations and modifications are conceivable within the scope of the claims.

According to one alternative, the second plate-shaped member 9 is made by crosscutting of a tube of square-shaped cross section.

The connection of a radially extending wall part of one to a radially extending wall part of an adjacent section can further be effected differently than arranging a cover plate therebetween. For example, the wall parts can be arranged relatively close together and connected by the application of material, or by welding or the like.

Further, the cover plates can be fixed in a number of different ways, such as riveting and gluing.

The mutual connection of two wall parts which are intended to define a gas duct, that is to say the connection of a wall part extending in the radial direction to a wall part extending in the circumferential direction, can be effected using a technique other than laser-welding, for example by soldering or another type of welding.

The manufacture of the wall parts can be affected in a number of different ways, for example by heat-forming and then cutting by laser, water jet or otherwise into the intended shape.

In the description above, each section is provided with two wall parts. It lies within the scope of the invention, however, for each section to have a different number of wall parts. According to one example, one section has three wall parts, which thus defines two ducts. Further, not necessarily all the sections in a component are identically configured, but rather different sections in the same component can have different numbers of wall parts.

Still further, in certain constructions the outer ring element 25 is not required.

1. A method for manufacturing a stator component (29, 129) which is intended during operation to conduct a gas flow, said method comprising:
constructing the component to be made up of at least two sections (13, 14, 15; 113) in a circumferential direction, which sections each have at least one wall part (1, 2; 101, 102) and the sections are placed adjacent to each other, and the two wall parts, one from each of two adjacent sections, are connected together to form a means (18, 19; 118, 119) extending in the radial direction of the component to guide said gas flow during operation of the component.

2. The method as recited in claim 1, wherein said means transmits load during operation of the component.

3. The method as recited in claim 1, wherein a first of said adjacent sections (13; 113) is constructed by a first wall part (1, 101) and a second wall part (2, 102) being spaced apart so as to define a gas duct (3, 103) therebetween in the circumferential direction.

4. The method as recited in claim 3, wherein the first and second wall parts (1, 2; 101, 102) are mutually arranged such that the component at least partially extends essentially in the radial direction.

5. The method as recited in claim 3, wherein a third wall part (5) is arranged to extend between the first and second wall parts and be connected thereto so as to define the gas duct in a first direction in the radial direction of the component.

6. The method as recited in claim 5, wherein the edge of the third wall part (5) is laser-welded to said first and second wall part (1, 2) from a circumferentially opposite side of the same in relation to the third wall part in such a way that the joined-together portions of the wall parts form a T-shaped joint (8).

7. The method as recited in claim 5, wherein said third wall part (5) constitutes an intermediate portion of a first plate-shaped member (4) which has a shape corresponding to the space between the first and second wall part and the plate-shaped member is placed between the first and second wall part.

8. The method as recited in claim 7, wherein a fourth wall part (10) extends between the first and second wall part (1, 2) and is connected thereto so as to define the gas duct in a second direction in the radial direction of the component.

9. The method as recited in claim 8, wherein the edge of the fourth wall part (10) is laser-welded to said first and second wall part from the circumferentially opposite side of the same in relation to the fourth wall part in such a way that the joined-together portions of the wall parts form a T-shaped joint (8).

10. The method as recited in claim 8, wherein said fourth wall part (10) constitutes an intermediate portion of a second plate-shaped member (9), which has a shape corresponding to the space between the first and second wall part, and in that this plate-shaped member is placed between the first and second wall part.

11. The method as recited in claim 10, wherein the first and second wall part (1, 2; 101, 102) are connected to at least one of an inner and outer ring element (24, 25; 31, 34) in the radial direction.

12. The method as recited in claim 11, wherein the first and second wall parts (101,102) form portions of an essentially U-shaped single element (30).

13. The method as recited in claim 12, wherein the base (33) of the U-shaped element (30) is connected to the inner ring element (31).

14. The method as recited in claim 13, wherein the side members of the U-shaped element (30) are connected to the outer ring element (34).

15. The method as recited in claim 14, wherein all the sections are constructed in the same manner as the first section.

16. The method as recited in claim 1, wherein the stator component (29, 129) has an essentially circular cross-sectional shape and a plurality of ducts for conducting the gas flow extend in the axial direction between an inner and an outer ring.

17. The method as recited in claim 16, wherein the stator component (29, 129) is intended for a gas turbine.

18. The method as recited in claim 17, wherein the stator component (29, 129) is configured for installation in a jet engine.
